(19) United States
(12) Patent Application Publication
(10) Pub. No.: US 2026/0209654 A1
(43) Pub. Date: Jul. 23, 2026

(54) Consumer sour beer additive

(71) Applicant: Robert Stephen Cormack, Sherman Oaks, CA (US)

(72) Inventor: Robert Stephen Cormack, Sherman Oaks, CA (US)

(21) Appl. No.: 19/031,926

(22) Filed: Jan. 18, 2025

(51) Int. Cl. C12C 5/02

(52) U.S. Cl. CPC C12C 5/026

(57) ABSTRACT

A method for transforming a standard serving of beer into a pseudo sour beer is provided, which is accomplished by dispensing and mixing an admixture of organic acids known to be responsible for the unique flavor profile of sour beers. The admixture is an aqueous solution containing a fixed proportion of lactic acid, acetic acid, malic acid, and anhydrous citric acid. The added acidulant imparts a tart, acidic, and sour flavor to the beer, mimicking the taste of a conventionally brewed sour beer.

### FIELD OF THE INVENTION

This invention relates to the flavoring of beers. In particular, the present disclosure relates to a method of imparting sour flavoring comprising a preparation consisting of an admixture of acidulants that a person may dispense into a bottle, can, or draught pour of beer.

### BACKGROUND OF THE INVENTION

The term “sour beer” refers to a type of beer crafted to be tart, acidic, and sour. Sour beers are typically made by introducing specific strains of yeasts, such as Brettanomyces, or bacteria, such as Pediococcus and Lactobacillus, into the brew (kettle souring) to generate a sour flavor profile in the beer. The added microorganisms metabolize the sugars in the brew and convert them into various acids, in particular, lactic acid, acetic acid, malic acid, and citric acid. In barrel aging, the sour flavor of the beer is generated by yeasts and bacteria naturally occurring in the wood of the barrel used in the aging process. The acids present in a sour beer are responsible for its distinct flavor, which is attributable to the acids'effect on both pH (concentration of free hydrogen ions) and titratable acidity (total amount of free and acid-bound hydrogen ions). Examples of popular sour beer styles include American wild ale, Berliner weisse, Flanders red ale, gose, and lambic.

Sour beers are among the most challenging beers to brew because they require meticulous attention during the fermentation process. Brewers must ensure the growth of the acid-producing yeast or bacterium with the alcohol-producing Saccharomyces yeast, which can easily outcompete these other microorganisms. Should the outcome of the fermentation be undesirable, brewers have learned to tailor the flavor profile of sour beers by adding a blend of acids into the fermentation batch, but this approach is uncommon and can result in inconsistent levels of acidity, and hence flavor, in the final beer product.

Produced mainly by small, independent (craft) breweries, sour beers have a relatively small market share and limited availability at licensed on-premise and off-premise alcohol outlets. Moreover, many of the sour beer products are infused with fruit, such as cherries, raspberries, and peaches. Although fruited sour beers are becoming increasingly popular, this flavoring has a narrow appeal to beer drinkers. Non-fruited sour beers are not commonly brewed and retailed.

### SUMMARY OF THE INVENTION

The present invention is embodied as a fully miscible admixture of acidulants contained in a disposable and portable container closure system for dispensing into a portion of beer. The dispensed admixture provides a method to impart a sour flavor profile to any non-sour beer. Each acidulant contributes unique notes of tartness, acidity, and sourness to the beer, and collectively, the ingredients reduce the pH of the beverage. The sour beer additive may be provided in a number of packaging formats that retain the properties and stability of the admixture, such as a glass vial. Each packaged dispensable unit of the additive, when emptied and mixed into a serving (300 mL to 500 mL) of non-sour beer, transforms the beverage into a pseudo sour beer.

The present invention resolves, in part, prior art difficulties in the manufacturing of sour beers and provides consumers the ability to convert any non-sour ale or lager into a sour beer. The resulting sour beer mimics the flavor of conventionally brewed sour beers.

### DETAILED DESCRIPTION OF THE INVENTION

In the preferred embodiment of the present invention, the additive is composed of an admixture of concentrated aqueous solutions of lactic acid (2-hydroxypropanoic acid; CH₃CHOHCOOH), acetic acid (CH₃COOH), malic acid (2-hydroxybutanedioic acid; HO₂CCH(OH)CH₂CO₂H), and anhydrous citric acid (2-hydroxypropane-1,2,3-tricarboxylic acid; HOC(CO₂H)(CH₂CO₂H)₂). The additive is formulated in uniform batches using proportions of each acidulant that will impart a verisimilitude of sour beer flavor upon addition and mixture with the selected serving of beer.

In the preferred embodiment of the present invention, the additive has a final concentration of lactic acid (90.1 g/mol) of 35% w/v or a molarity of 3.9 M.

In the preferred embodiment of the present invention, the additive has a final concentration of acetic acid (60.1 g/mol) of 10% w/v or a molarity of 1.7 M.

In the preferred embodiment of the present invention, the additive has a final concentration of malic acid (134.1 g/mol) of 5% w/v or a molarity of 0.37 M.

In the preferred embodiment of the present invention, the additive has a final concentration of anhydrous citric acid (192.1 g/mol) of 3% w/v or a molarity of 0.16 M.

In the preferred embodiment of the present invention, the batches of the additive are packaged in dispensable units of 10 mL in suitable screw-top vials (glass or polymer) sealed with screw caps.

Upon mixing the dispensable unit of the additive with the serving of the selected beer, the pH of the beverage is significantly lowered (acidified). The resultant lowered pH of the beverage contributes to the distinctive flavor typically associated with traditional sour beers.

Upon mixing the dispensable unit of the additive with the serving of the selected beer, the titratable acidity of the acidulants in the beverage is altered. The resultant titratable acidity of the beverage contributes to the distinctive flavor typically associated with traditional sour beers.

What is claimed is:

1. A method of transforming a non-sour beer into a pseudo sour beer comprising an additive wherein the composition is an aqueous liquid, wherein the composition is configured to dispense and mix in a serving (300 mL to 500 mL) of beer, the composition comprising an admixture of:
a) 3.9 M lactic acid;
b) 1.7 M acetic acid;
c) 0.37 M malic acid;
d) 0.16 M anhydrous citric acid; and
e) distilled water q.s. to 10 mL.

2. The method of claim 1, wherein the additive has a composition of lactic acid that ranges from 3.5 M to 4.3 M.

3. The method of claim 1, wherein the additive has a composition of acetic acid that ranges from 1.5 M to 1.9 M.

4. The method of claim 1, wherein the additive has a composition of malic acid that ranges from 0.33 M to 0.40 M.

5. The method of claim 1, wherein the additive has a composition of anhydrous citric acid that ranges from 0.14 M to 0.18 M.

6. The method of claim 1, wherein the additive has a q.s. volume of distilled water that ranges from 5 mL to less than 10 mL.

7. The method of claim 1, wherein the additive lowers the pH of the serving of beer thus imparting a distinctive flavor to the beverage and mimicking a sour beer.

8. The method of claim 1, wherein the additive alters the titratable acidity of the serving of beer thus imparting a distinctive flavor to the beverage and mimicking a sour beer.

9. The method of claim 1, wherein a half proportion or other proportion to taste is dispensed and mixed with a serving of beer.

10. The method of claim 1, wherein the additive is dispensed and mixed with an alcoholic or non-alcoholic ale or lager or other style of beer.
